(19) United States
(12) Patent Application Publication
(10) Pub. No.: US 2012/0325127 A1
(43) Pub. Date: Dec. 27, 2012

(54) INTRUSION DETERRENCE ACCESSORY DEVICE

(76) Inventor: John B. Adrain, Spokane, WA (US)

(21) Appl. No.: 13/530,617

(22) Filed: Jun. 22, 2012

Related U.S. Application Data
(60) Provisional application No. 61/499,747, filed on Jun. 22, 2011.

(51) Int. Cl. G08B 15/02; E05G 1/10

(52) U.S. Cl. 109/31; 109/32

(57) ABSTRACT

An intrusion deterrence accessory device for an enclosure having an original door or panel for limiting access to the enclosure includes a replacement door or panel for the enclosure, the door or panel being directly substitutable for the original door or panel; a dispenser for a deterrence substance operably mounted to the replacement door or panel; and an intrusion sensor operably mounted to the replacement door, wherein the dispenser is operable to dispense the deterrence substance when an intrusion is sensed by the intrusion sensor.

The present invention relates to security systems and, in particular, to systems that dispense substances to deter intrusion.

### BACKGROUND OF THE INVENTION

Certain enclosures need to be protected from access by unauthorized personnel. Examples of such enclosures include, but are not limited to, a power control panel, a water control panel, a telephone panel, a safe, a computer rack heating controller, fluid control panels, and railway track controls. Occasionally, a mere physical lock on the enclosure will not prevent an intruder from forcing access to the enclosure. Even an audible alarm may not be a sufficient deterrent if the enclosure is, for example, located in a remote area. For example, intruders enter onto a cell tower site, break into the power panel, shut off the power, and steal copper from the cell tower site. Other deterrence means are needed either to prevent the intruder from accessing the enclosure or doing much inside it once accessed, or to mark the intruder for later identification.

In many cases, the need for such protection has not been anticipated. For example, the epidemic of copper theft is a relatively new phenomenon. Also the need to protect important infrastructure from terrorist activities has only recently become apparent. As a result, many important resources are still protected only by simple doors or panels.

### SUMMARY OF THE INVENTION

An intrusion deterrence accessory device for an enclosure having an original door or panel for limiting access to the enclosure includes a replacement door or panel for the enclosure, the door or panel being directly substitutable for the original door or panel; a dispenser for a deterrence substance operably mounted to the replacement door or panel; and an intrusion sensor operably mounted to the replacement door, wherein the dispenser is operable to dispense the deterrence substance when an intrusion is sensed by the intrusion sensor.

In a further embodiment of the invention, the deterrence substance comprises a member selected from the group including pepper spray (oleoresin capsicum spray), tear gas spray, ink, malodorous spray, and lethal gas or spray.

In a further embodiment of the invention, the intrusion sensor comprises an infrared motion sensor or a trip wire. In a further embodiment of the invention, the accessory device can be triggered remotely by an output from another device.

A further embodiment of the invention further includes a disabling mechanism, which disables emission of the deterrence substance once the disabling mechanism is activated by an authorized person. In a further embodiment of the invention, the disabling mechanism includes a member selected from the group including a key switch, a keypad, a thumb print reader, a voice print detector, an iris scanner, a cell phone, and a remote control.

A further embodiment of the invention further includes a wired or wireless communication system for transmitting diagnostic information and/or audio and/or video captured at the enclosure. In a further embodiment of the invention, the diagnostic information includes a member selected from the group including battery life, power supply, intrusion sensor status, and deterrence substance level. In a further embodiment of the invention, the communication system comprises an Internet protocol communication system, a Bluetooth communication system, or a cell phone communication system.

In a further embodiment of the invention, the enclosure comprises a member selected from the group including a power panel, a water panel, a gas panel, a liquid panel, a telephone panel, a safe, a computer rack heating controller, a fluid controller, and a railway track controller. In a further embodiment of the invention, the enclosure is a power panel at a cell tower site.

A further embodiment of the invention further includes a warning to an unauthorized person approaching the enclosure. In a further embodiment of the invention, the warning is given as a verbal command from within the enclosure.

### BRIEF DESCRIPTION OF THE DRAWINGS

FIG. 1 is a front-perspective view of an enclosure with an embodiment of the intrusion deterrence accessory device, with the enclosure door closed and a deterrent spray triggered; and

FIG. 2 is a front-perspective view of an enclosure with an embodiment of the intrusion deterrence accessory device, with the enclosure door open and the spray triggered.

### DETAILED DESCRIPTION OF THE INVENTION

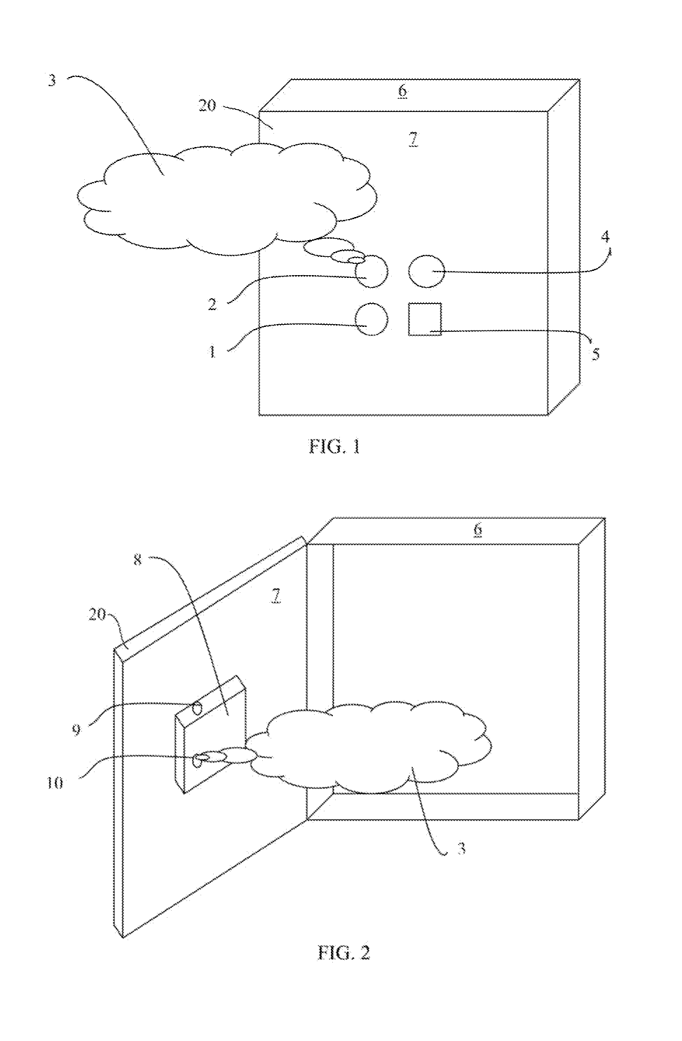

FIG. 1 and FIG. 2 show one possible embodiment of the invention. The intrusion deterrence accessory device 20 includes a replacement door or panel 7 for an enclosure 6 (e.g., a cell tower power panel enclosure). The accessory device 20 further includes a dispenser 8 for a deterrence substance attached to the interior side of the replacement door or panel 7 and an intrusion sensor 4 attached to the door or panel 7 to sense intrusion of the enclosure 6. Besides actual intrusion, the sensor 4 may also detect potential intrusion, such as unauthorized personnel in proximity to the enclosure 6 and treat this as an intrusion as well. When the sensor 4 senses an intrusion it signals the deterrence dispenser 8 to dispense a deterrence substance.

The replacement door or panel 7 is preferably specifically constructed to be a direct replacement for the original door or panel of the enclosure 6. For example, the replacement door or panel 7 may be deeper (e.g., 3 inches) to accommodate the dispenser 8 and the sensor 4 as well as any other desired components of the accessory device 20. In other aspects, it is desirable for the replacement door or panel 7 to be essentially the same as the original door or panel to help ensure easy replacement of the original.

The sensor 4 can sense when an intruder is attempting to gain access to the enclosure 6 and dispenser 8 can dispense a deterrence substance spray 3 at the intruder, thus deterring entry. Examples of a dispenser and a sensor for deterring intrusion are shown in U.S. Pat. No. 5,796,330 and U.S. Patent Application Publication Nos. 2010/0128123 and 2002/0057365 which are incorporated herein by reference.

Various deterrence substances can be employed, for example, pepper spray (oleoresin capsicum spray), tear gas spray, and an identifying spray, such as ink, which will mark the intruder for later identification. Another possibility includes a malodorous spray that irritates the intruder, due to the foul odor, and allows later identification, due to the odor. Another possibility can be the use a lethal gas or spray.

The accessory device 20 can be powered by batteries or power can be derived from power mains. The power mains may power the accessory device 20 by line-voltage, directly or through a step-down transformer, with a battery serving as backup.

Another embodiment of the invention can include sensing whether the replacement door or panel 7 is open or closed during intrusion. As shown in FIG. 1, if the replacement door or panel 7 is closed, the accessory device 20 can emit the deterrence substance 3 outside the enclosure 6 by a nozzle 2 pointing out of the enclosure 6. As shown in FIG. 2, if the replacement door or panel 7 is open, the accessory device 20 can emit the deterrence device 3 inside the enclosure 6 by a nozzle 10 pointing into the enclosure 6.

The intrusion sensor 4 may be, for example, as simple as a trip wire or a door switch, or more sophisticated, such as infrared motion sensors, microwave sensors, vibration sensors or video sensors.

Another embodiment of the invention can include continuously emitting the deterrence substance 3 for a short period once the dispenser 8 is activated, and then pulsing the dispenser 8 on and off periodically. For example, the initial period can be 5 seconds, with subsequent dispensing periods being 4 seconds on and 10 seconds off.

Another embodiment of the invention can include diagnostic monitoring of the accessory device. Diagnostic information can be transmitted to another location via a communication link 9, whether wired or wireless. Common communication links include, but are not limited to, TCP/IP, cell phone, Bluetooth, Wi-Fi, and LAN. Utilizing such common communication methods can allow the intrusion deterrence accessory device to easily interface with existing equipment. Diagnostic information can include, but is not limited to, battery life, power supply, deterrence substance level, and sensor status. Once a deterrence substance container is empty, a diagnostic message can be sent by the accessory device indicating a refill of the dispenser is needed.

Another embodiment of the invention can include audio and/or video sensors 1 that can record audio and/or video captured at the enclosure location. Additionally, such audio and/or video can be transmitted to another location via the communication link.

In another embodiment of the invention, the dispenser 8 can be triggered remotely by an output from another device, such as a camera, a cell phone, or a computer. For example, after a remote operator receives captured audio and/or video from the accessory device 7 and notices intruders near the enclosure 6, the operator can send a command via the Internet to activate the dispenser 8.

Another embodiment of the invention can include several spray containers, where the system can switch to a different container if the current one is empty.

Another embodiment of the invention can include a disabling mechanism 5 to disable the dispenser 8, which allows authorized personnel to access the enclosure 6. Such a disabling mechanism 5 can include, but is not limited to, a key switch, a keypad by which a code can be entered, a thumb print scanner, an iris scanner, a voice print detector, and a remote control.

Another embodiment of the invention can allow the accessory device to warn an intruder of the imminent dispensing of the deterrence substance 3 unless the intruder ceases the intrusion and leaves. Such a warning can be triggered by the intrusion sensor 4 and be given prior to initiating the dispensing of the deterrence substance. Such a warning can be a pre-recorded audio command that is stored on a player inside the dispenser 8, and is played via a speaker inside the enclosure 6. Such a warning can also be a visual message displayed on a screen of the enclosure 6.

This invention can be used to protect enclosures from intrusion. Examples of such enclosures include, but are not limited to, enclosures that control any type of power source, such as electric, gas, or liquid. The intrusion deterrence accessory device of this invention can be installed and used indoors or outdoors on the enclosure to be protected. Because the enclosure 6 can be retrofitted by replacing the original door or panel with the accessory device 20, it becomes very simple to improve the security of the enclosure 6 without replacing the entire enclosure. An additional advantage is that down time for whatever functions the contents of the enclosure are intended to perform are minimized. Maintenance of such enclosures can also be relatively low-cost and time-efficient because the accessory device 20 can simply be replaced with a new one if the intrusion deterrence system malfunctions, while leaving the rest of the enclosure 6 as is.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An intrusion deterrence accessory device for an enclosure having an original door or panel for limiting access to the enclosure, the device comprising:
a replacement door or panel for the enclosure, said door or panel being directly substitutable for the original door or panel;
a dispenser for a deterrence substance operably mounted to said replacement door or panel; and
an intrusion sensor operably mounted to said replacement door, wherein the dispenser is operable to dispense the deterrence substance when an intrusion is sensed by said intrusion sensor.

2. An accessory device according to claim 1, wherein the deterrence substance comprises a member selected from the group comprising pepper spray (oleoresin capsicum spray), tear gas spray, ink, malodorous spray, and lethal gas or spray.

3. An accessory device according to claim 1, wherein the intrusion sensor comprises an infrared motion sensor or a trip wire.

4. An accessory device according to claim 1, wherein the intrusion sensor can be triggered remotely by an output from another device.

5. An accessory device according to claim 1, further comprising a disabling mechanism, which disables dispensing of the deterrence substance once the disabling mechanism is activated by an authorized person.

6. An accessory device according to claim 5, wherein the disabling mechanism comprises a member selected from the group comprising a key switch, a keypad, a thumb print reader, a voice print detector, an iris scanner, a cell phone, and a remote control.

7. An accessory device according to claim 1, further comprising a wired or wireless communication system for transmitting diagnostic information and/or audio and/or video captured at the enclosure.

8. An accessory device according to claim 7, wherein the diagnostic information comprises a member selected from the group comprising battery life, power supply, intrusion sensor status, and deterrence substance level.

9. An accessory device according to claim 7, wherein the communication system comprises an Internet Protocol communication system, a Bluetooth communication system, or a cell phone communication system.

10. An accessory device according to claim 1, wherein the enclosure comprises a member selected from the group comprising a power control panel, a water control panel, a gas control panel, a liquid control panel, a telephone panel, a safe, a computer rack heating controller, a fluid controller, and a railway track controller.

11. An accessory device according to claim 1, further comprising a warning device operable to warn an unauthorized person approaching the enclosure.

12. An accessory device according to claim 11, wherein the warning is given as a verbal command from within the enclosure.

13. An accessory device according to claim 1, wherein the enclosure is a power panel at a cell tower site.
